(19) United States
(12) Patent Application Publication
(10) Pub. No.: US 2002/0077887 A1
(43) Pub. Date: Jun. 20, 2002

(54) Architecture for anonymous electronic voting using public key technologies

(75) Inventors: Theodore Jack London Shrader, Austin, TX (US); Lok Yan Leung, Austin, TX (US); Anthony Joseph Nadalin, Austin, TX (US); Bruce Rich, Round Rock, TX (US)

Correspondence Address: Darcell Walker, 8107 Carvel Lane, Houston, TX, 77036, US

(73) Assignee: IBM Corporation

(21) Appl. No.: 09/738,248

(22) Filed: Dec. 15, 2000

(51) Int. Cl. G06F 17/60

(52) U.S. Cl. 705/12

(57) ABSTRACT

The present invention discloses an architecture that enables anonymous electronic voting over the Internet using public key technologies. This invention provides a simple yet robust architecture for electronic voting over the unsecured network that is the Internet, using the public and private key pair belonging to the voting entity, not a separate userid and password for each election. In the voting method of the present invention, a voting entity requests a ballot using a public key and a private key belonging to the voting entity. The request is made to a voting mediator. Using a separate public key/private key pair, the voting mediator validates the voting ballot request. After validation of the request, the voting mediator generates an election ballot. The voting mediator sends this ballot to the voting entity. The voting entity casts a vote and sends the ballot to the voting tabulator. The voting tabulator authenticates the ballot and counts the vote.

### TECHNICAL FIELD OF THE INVENTION

The present invention relates in general to voting systems, which are implemented using data preprocessing systems, and in particular to an electronic voting system having an architecture that allows anonymous voting over a global computer networks such as the Internet using public key technologies.

### BACKGROUND OF THE INVENTION

Throughout the world, many countries have adopted the western model of government, in which “qualified” and “registered” voters elect a variety of local, state, and federal officials to particular offices. Traditionally, western-style elections are conducted utilizing paper ballots, which are issued to registered voters at particular polling places. This process requires the physical attendance of the voter at a particular polling place in order for them to vote. In many countries, such as the United States of America, voter participation has been poor, perhaps largely due to the burdens of work and family which make fairly strenuous demands on the citizens. Another problem associated with western-style elections is the tremendous expense associated with conducting the elections in a manner, which renders the election results substantially free from corruption and error. The goals of maximizing convenience, minimizing expense, minimizing security risks and increasing election result accuracy are all challenges found in democratic forms of elections.

Two other concerns also figure prominently in systems, in democratic elections. The first concern is the voter's right of privacy to his or her voting decisions. The second consideration is the ease with which particular votes can be challenged (for lack of “qualification” of the voter) and corrected without presenting risks to the security and privacy of the votes in general. All of the events surrounding the 2000 presidential election exposed many of the deficiencies in the main way in which most people vote for public officials.

The rising importance of the Internet and other forms of electronic communication in the United States of America and abroad presents a unique opportunity to reduce the inconvenience and expense associated with traditional voting systems. However, there are a considerable number of concerns about security and privacy which will have to be met before the internet and/or other forms of electronic communication becomes viable as a substitute for or supplement to traditional paper ballot type elections.

Traditionally, the process of registering citizens to vote, preparing ballots, conducting elections and tabulating results has been one of the most disjointed, inefficient and resource intensive of all government projects. As a result, the Internet is now being called upon, as it has been in almost every other industry, to help revolutionize the system.

Internet voting has been referred to as the ultimate challenge in network security and data encryption. Currently, internet-based election systems are in the early stages of development and testing. A number of organizations (both public and private) are competing to be the first-to-market with their Internet-based voting systems. The organizations are utilizing some of the best engineers, scientists, and technologies in the world to create the extremely complex systems and infrastructures that will be required to conduct secure elections over the Internet.

The movement toward Internet-based elections is, of course, a highly controversial topic. Interest groups have formed on both sides of the issue and have been passionately arguing their cases for quite some time. Proponents of Internet voting believe that the new technology will (1) increase voter participation, (2) add a much needed element of convenience to the voting process, (3) allow the electorate to be more knowledgeable and informed, (4) greatly increase the efficiency and security of elections, and (5) make access to the democratic process more widely available. Critics of Internet voting claim that the technology required to properly authenticate voters and assure the accuracy and integrity of the election system either does not exist or is not widespread enough in society to be equitable and effective. They also argue that the “digital divide” would further skew political power toward affluent non-minorities; that making it easier to vote will cheapen the value of our most sacred right; and that private companies cannot be trusted authorities in the administration of public sector elections.

In the United States, the primary components of traditional voting systems are basically the same from state to state. In general, voter registration is currently accomplished through a voter registration application that is completed by the voter and returned to an election office for inclusion in the voter registration list. This form allows voters to provide information about their qualifications for voting as well as a physical signature. The signature performs two important tasks. First, it attests to an oath, under penalty of perjury, that the voter has filled in the form truthfully. Second, it serves as positive identification, which secures the voter's absentee ballot and initiative rights. Unfortunately, the current voter registration systems are largely honor systems. Each county election department currently accepts the voter registration forms at face value and enters the voter onto the roles with little or no further investigation.

Following the voter registration, the next step is the development of the ballot. Election officials must carefully create a separate ballot, which adheres to standards and guidelines set forth by law. Once the ballots have been created they must be printed in sufficient quantity to serve the estimated number of voters who will turn out to vote on Election Day. The formula for deciding how many ballots to print is rather unscientific in most states. For example, some states simply order the number of ballots used in the previous election plus an additional percentage. This practice tends to lead to a large amount of waste either in unused ballots, or in expensive emergency printing if a poll runs out of ballots too soon.

Once the ballots have been printed, they are individually inspected and entered into a ballot register. The ballots are then placed in storage until Election Day. When they are removed from storage, the ballots are again manually inspected to ensure that no tampering has occurred. Needless to say, this is an extremely labor and resource intensive process.

The absentee voting process is entirely separate from the normal election process. In some states, voters are required to request absentee ballots either in person, via letter, or over the telephone (this applies to many other states as well). An ongoing request may also be made, which allows the voter to receive an absentee ballot for all future elections (some states require an annual request for an absentee ballot). Absentee ballots are either handed to the voter over-the-counter or delivered by the U.S. Postal Service. The voter must fill out his/her ballot and seal it inside a security envelope. The security envelope is then sealed inside another envelope that has an oath printed on it that the voter must sign. The ballot is then returned to the election office either in person or via the Postal Service. At the election office the absentee ballot signature is checked against the voter's file signature. Once verified, it is the only ballot that will be accepted from the voter. The outer envelope is then opened and removed leaving the security envelope sealed with the ballot inside for later opening. This separation of the ballot from all identifying materials insures the voter's secrecy and anonymity. On Election Day, all of the security envelopes are opened and the ballots are processed and counted. This process sounds and is complicated. The current voting system is extremely inefficient and opportunities for fraud exist throughout the process.

Advanced research into Internet-based elections is being fueled by a growing interest among public officials and interest groups that are frustrated by ever-dwindling participation numbers at the polls. In 1996, over 100 million people who were eligible to vote did not do so, and in 1998 the turnout rate for the general election in the United States was only 44.9 percent, ranking 138th in a list of 170 Democratic nations. This same year only 15 percent of people between the ages of 18 and 24 voted. Proponents of Internet voting claim that this Internet savvy age group would show up at the polls in record numbers if they were allowed to vote online. At the present time, many youth of voting age do not vote. “They are on the Internet in droves, and it is expected that they will begin to move to voting as the Internet does.”

There are many reasons for pursuing ways to voting process via a global computer network such as the Internet. Perhaps the most compelling argument in favor of Internet voting is the convenience factor. Convenience encourages participation, which should lead to a stronger electorate. One writer equated traveling to a voting booth in order to participate in an election to being forced to go to the Post Office in order to send e-mail. Steps have already been taken in the electoral process to take the burden off of the voter. For example, the Federal Election Commission is already making it easier for Web surfers to register to vote. By visiting certain web sites, computer users can download a voter registration form, print it, fill it out and then mail it to the local election official (if they live in one of the states that have agreed to accept the online form). Officials also realized that an online form could both reduce the states' costs and make it easier for people to register. Before one can vote, they need to have registered, often several weeks before an election. Then the person must go to the designated polling site and stand in line to cast his/her vote. If that person will be away from home on Election Day, they have to think ahead about getting an absentee ballot. Internet voting would eliminate these hassles.

With the growth of political sites of all persuasions on the World Wide Web, no one party stands to gain disproportionately from the online form. The reason that it is still not possible to actually register to vote online is that states require a prospective voter to physically sign his or her registration affidavit. This practice could change with the creation of digital signatures or other electronic identity verification systems.

The Early Voter Program is an example of a program that was put in place to increase convenience in the election process and hopefully improve turnout as well. For early voting, polling booths are set up in shopping malls and other public areas a week before the main election for anyone who wants to cast their ballot early.

One state has gone even further. It is now using a vote by mail system exclusively. This was implemented because the electorate wanted the convenience of voting from home on their “own” time.

Bringing elections, registration, and initiative petitions to cyberspace by legalizing Internet voting and employing digital certificates will piggyback on the growing use of the Internet. It will enable people to do something online that they want to do anyway, but have, of late, not been able to do because they are too busy and the traditional process is to inconvenient, not because they are too apathetic.

Another reason for establishing the ability to vote on the Internet is that Internet voting may be the quickest, cheapest, and most efficient way to administer elections and count votes. An Internet-based voting system would free up geographic location as an absolute requirement for where you vote. Once Internet voting is widely available over personal Internet devices, the true efficiency of the Internet will finally be realized for this historically segmented and inefficient process.

Examples of public entities harnessing the power of the Web are everywhere. Interactive election Web sites are proving to be extremely beneficial to state and county officials, who report decreases in the volume of phone calls to their offices, and an increase in interest among voters in additional aspects of the elections.

In most election divisions of county clerk's offices, the use of the Internet began as a way to answer thousands of redundant questions that are posed to them during the election season, such as how to register and where to vote. However, officials quickly recognized that the medium possessed far greater potential than simply acting as a community fact sheet. Instead, the Internet offers a way to communicate directly with the electorate, and many observers believe that today's election Web sites are simply a staging ground for a more ambitious goal: online voting.

The dollar amounts that could be gained in efficiency and consolidation are still speculative, but the larger states, for example, could probably cut considerable costs. Most states have separate county entities. Each county can use its own system of voting, provided that the State approves the system. The counties are responsible for integrating all of the voting processes on Election Day. Then another funneling effect occurs in the Secretary of State's Office. Tedious duties such as counting every ballot twice and double-checking the process to avoid human error cost millions of dollars. This concern was evident in the 2000 presidential election. Often, public administrators consider Internet voting not because the voter would be more informed or the turnout would increase, but simply because an online voting system would cost less and save time.

Critics argue that the true costs of an Internet election because there has been no statewide or federal election conducted using the Internet. Critics also contend that the social costs could cancel out any monetary efficiency that would be created.

Security is the number one concern for election officials because stuffing virtual ballot boxes in a public election could have dire consequences. The most important step in assuring the security of a voting system is the verification of individual voters There has to be certainty that the voters are actual voters, that each person only gets one vote, that the tabulation method is accurate, and that the provisional ballots are reconciled with the Internet ballots. This is indeed a difficult technical issue. In fact, some experts have said that recreating the extremely complex election process on a computer is one of the most difficult programming and cryptographic challenges ever to have been attempted. However, this is where the public and private organizations that are developing Internet voting systems shine. They have focused an enormous amount of energy and resources on overcoming the technical challenges of secure Internet voting. A number of companies already have working systems in place and are testing them for use in public elections.

The registrar must assure that each registered voter is qualified and legally competent to vote. However, current legal constraints make this problematic without legislation. There are some major tasks to accomplish to insure integrity in the election process when using the Internet. Assuming a “clean” registration list, it is also imperative to verify that a voter “presenting” him or herself to vote electronically is in fact the same person who has qualified and legally registered.

Transmission of votes from the voter to the election center must be guaranteed to be secure. Since the Internet is a packet-distributed network, the voting preferences of citizens should not be able to be viewed or altered by sites that lie between the voting location and the vote counting destination.

There must be assurance that all votes cast were indeed counted and attributed correctly. As each vote is cast, an unaltered record must be created ensuring a verifiable electronic audit trial.

There have been some efforts to apply automation techniques to the traditional voting processes. U.S. Pat. No. 6,081,793 provides an electronic voting method and system that optionally allows paper ballots. A plurality of cryptographic routines is used to maximize the privacy of both the voter's identity and the content of a completed ballot. U.S. Pat. No. 5,218,528 provides an automated voting system that implements stages of registering and certifying votes and collecting their votes.

There still remains a need for an electronic voting system that enables voting on a global computer network, which provides greater security and privacy than the present or past voting systems.

### SUMMARY OF THE INVENTION

It is an objective of the present invention to provide an improved method and system for voting which allows for electronic voting utilizing a global computing network which maintains at least the same level of security and privacy of the current and conventional voting systems;

It is another objective of the present invention to provide an electronic voting method and system that is anonymous and confidential.

It is another objective of the present invention to provide an electronic voting method and system that does not require the voter to use a separate user identification and password for each election.

It is another objective of the present invention to provide an improved election voting method and system that has an architecture which that contains checks and balances to protect against voting fraud; and

It is another objective of the present invention to provide an improved method and system for facilitating and tabulating the election results and improving election results.

This invention provides a simple yet robust architecture for electronic voting over the unsecured network that is the Internet, using the public and private key pair belonging to the voting entity, not a separate user identification and password for each election.

In the voting method of the present invention, a voting entity requests a ballot using a public key and a private key belonging to the voting entity. The request is made to a voting mediator. Using a separate public key/private key pair, the voting mediator validates the voting ballot request. After validation of the request, the voting mediator generates an election ballot. The voting mediator sends this ballot to the voting entity. The voting entity casts a vote and sends the ballot to the voting tabulator. The voting tabulator authenticates the ballot with the voting mediator and counts the vote.

### DESCRIPTION OF THE DRAWINGS

FIGS. 1a and 1b depict data processing equipment a system that can be utilized to implement the present invention;

FIG. 2 is a typical paper voter registration certificate used to verify the registration of an individual voter;

FIG. 3 is a diagram of the main components of the present invention and the relationship of the components to each other;

FIG. 4 is a flow diagram representing the main steps involved in the implementation of the present invention;

FIG. 5 is a flow diagram representing the steps to request a voting ballot for a particular election;

FIG. 6 is a flow diagram representing the steps necessary to authenticate the voting ballot request and to send an official ballot to the requesting voter;

FIG. 7 is a flow diagram representing the steps necessary for the voter to cast a ballot in accordance with the present invention; and

FIG. 8 is a flow diagram of the steps involved in the validation of the official ballot and the tabulation of the votes.

### DETAILED DESCRIPTION OF THE INVENTION

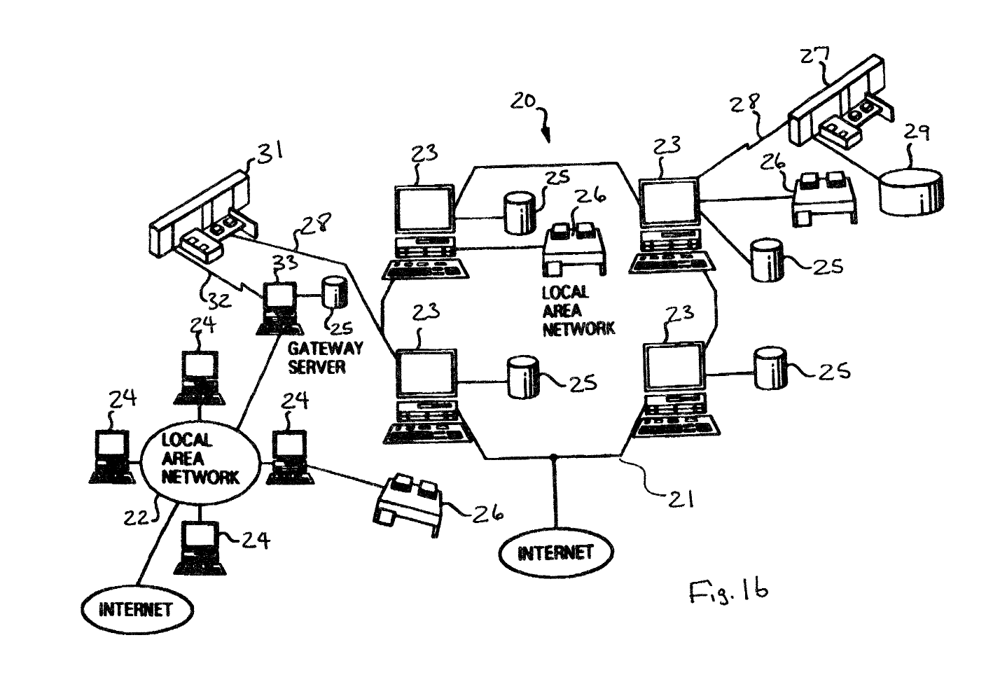

The traditional and most often used procedure for voting involves the use of a paper ballot. Registration to vote in the particular jurisdiction where the voter resides is a requirement for that person to vote in any election. During the registration process, eligible voters receive a voter registration certificate. As shown in FIG. 2, the certificate can contain information about the voter and a list of the positions for which the person can vote. This information includes the voter's address 1, certificate number 2, validity dates of the certificate 3, voter precinct number 4, U.S. Representative 5, state senator 6, state representative 7, justice of the peace 8, and voter signature 9. The voter's name and address is included on a list of registered voters for that precinct. On the date of the election, the voter can present his or her voter certificate at the proper voting location, receive a ballot and vote in the different election races.

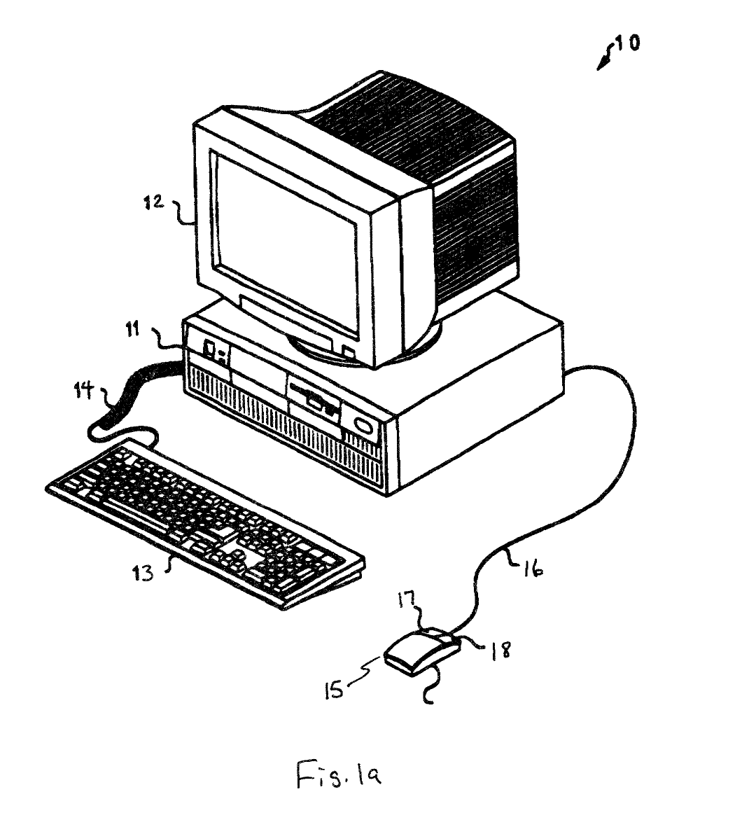

With reference now to FIG. 1a, there is depicted a pictorial representation of data processing system 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

The method of the present invention may be implemented in a global computer network environment such as the Internet. With reference now FIG. 1b, there is depicted a pictorial representation of a distributed computer network environment 20 in which one may implement the method and system of the present invention. This diagram illustrates the types of components through which sensitive and confidential; voting information may be exposed and the need for extreme security in this voting process. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 1b, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

The present invention provides a method and system for voting over a global computer network (the Internet). Because of the use of Internet facilitates in this confidential and critical activity (voting) and the importance of the results, networks need strong security features to prevent unwelcome access and to protect private data as it traverses the public network and to protect the integrity of this process. User authentication and Data Encryption schemes provide the ability to authenticate, encrypt and decrypt certain information. This present invention implements a public key/private key encryption scheme to protect data as it traverses the public networks.

Symmetric, or private key, encryption (also known as conventional encryption) is based on a secret key that is shared by both communicating parties. The sending party uses the secret key as part of the mathematical operation to encrypt (or encipher) plaintext to ciphertext. The receiving party uses the same secret key to decrypt (or decipher) the ciphertext to plaintext. Examples of symmetric encryption schemes are the RSA RC4 algorithm (which provides the basis for Microsoft Point-to-Point Encryption (MPPE), Data Encryption Standard (DES), the International Data Encryption Algorithm (IDEA), and the Skipjack encryption technology proposed by the United States government (and implemented in the Clipper chip).

Asymmetric or public key encryption uses two different keys for each user: one key is a private key known only to the user to which the key pair belongs; the other is a corresponding public key, which is accessible to anyone. The encryption algorithm mathematically relates the private and public keys. One key is used for encryption and the other for decryption, depending on the nature of the communication service being implemented. In addition, public key encryption technologies allow digital signatures to be placed on messages. A digital signature uses the sender's private key to encrypt some portion of the message. When the message is received, the receiver uses the sender's public key to decipher the digital signature as a way to verify the sender's identity and the integrity of the message.

With symmetric encryption, both the sender and receiver have a shared secret key. The distribution of the secret key must occur (with adequate protection) prior to any encrypted communication. However, with asymmetric encryption, the sender uses the recipient's public key to encrypt or digitally sign messages, while the receiver uses their key to decipher these messages. The public key can be freely distributed to anyone who needs to encrypt messages to the owner of the public key or to verify digitally signed messages by the private key that corresponds to the public key. The owner of the key pair only needs to carefully protect the private key.

To secure the integrity of the public key, the public key is published with a certificate. A certificate (or public key certificate) is a data structure that is digitally signed by a certificate authority (CA). The CA is an authority that users of the certificate can trust. The certificate contains a series of values, such as the certificate name and usage, information identifying the owner of the public key, the public key itself, an expiration date, and the name of the certificate authority. The CA uses its private key to sign the certificate. If the receiver knows the public key of the certificate authority, the receiver can verify that the certificate is indeed from the trusted CA, and therefore contains reliable information and a valid public key. Certificates can be distributed electronically (via Web access or e-mail), on smart cards, or in an LDAP database. Public key certificates provide a convenient, reliable method for verifying the identity of a sender. IPSec can optionally use this method for end-to-end authentication.

This invention utilizes public and private key pairs for each party involved in the voting transaction. A public and private key pair is a unique association of key values wherein one key can encrypt information and the other can decrypt. For example, the public key can encrypt data and only the corresponding private key can decrypt the data. Public and private keys are used for signing and sending encrypted messages. A public key is typically made available to users on a global computer network (the Internet) within a certificate stored in a publicly accessible Lightweight Directory Application Protocol (LDAP) directory. The associated private key is kept in confidence by the entity, such as the person or cooperation that owns the key pair.

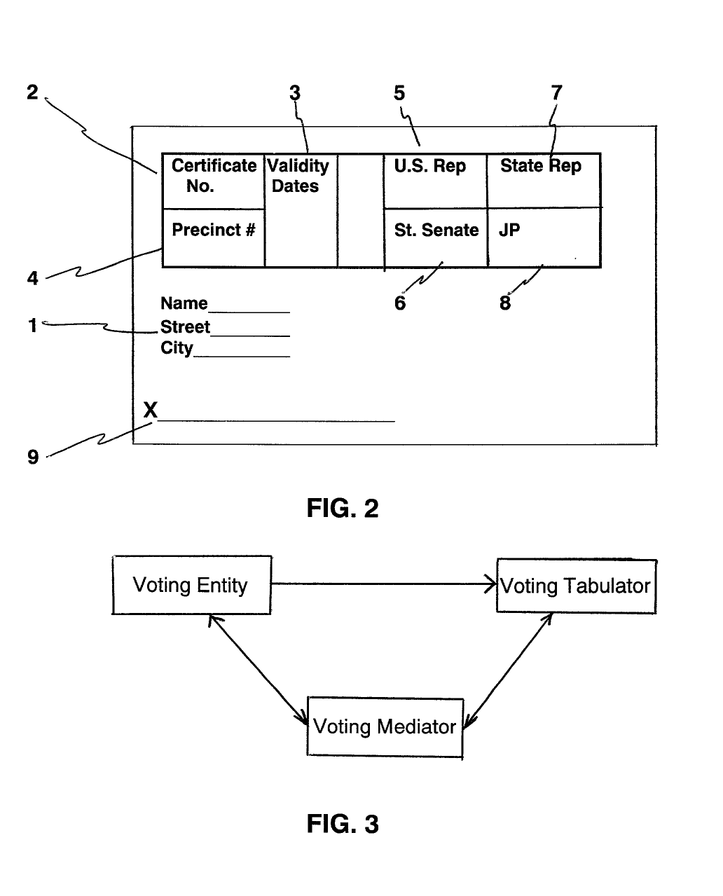

As shown in FIG. 3, the present invention has an architecture with three main components:

Voting entity—The client process representing a person or group that will be voting in the election.

Voting mediator—The server process that authorizes and creates the anonymous electronic ballot for the voting entity.

Voting tabulator—The server process that receives and validates the electronic ballot and tabulates the election results. The voting tabulator is unique per election.

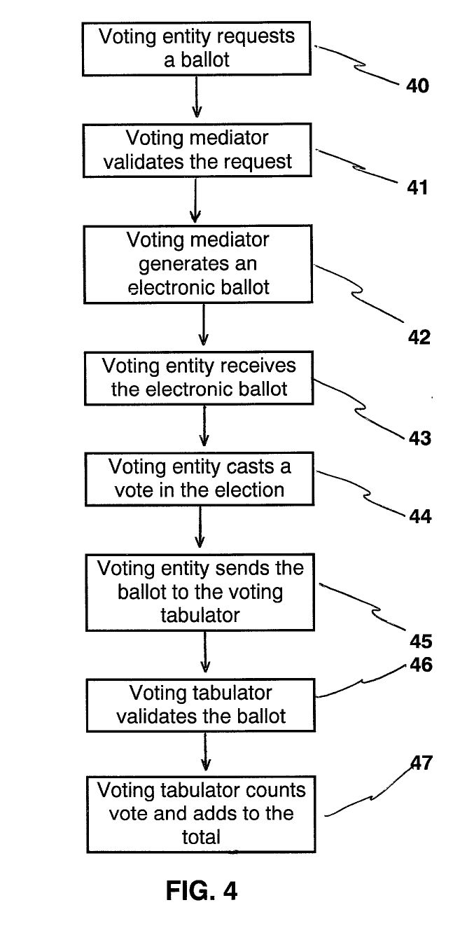

In this process, each party participating in the voting transaction has a unique public key and private key pair. As previously discussed, each key pair serves to protect and secure the transaction by providing the means to encrypt, decrypt, authenticate and validate information and verify sources and destinations of information. The FIGS. 4, 5, 6, 7, and 8, illustrate the general and specific steps for performing a voting transaction in accordance with the present invention.

Referring to the drawings, FIG. 4, describes the general steps of the voting transaction. In step 40, the voting entity requests an electronic voting ballot. The voting entity makes this request to the voting mediator. The voting mediator receives and validates the voting request 41. After the validation of the voting request, the voting mediator generates an electronic ballot 42. The voting entity receives a ballot 43 and casts a vote 44. The voting entity sends the ballot to the voting tabulator 45. The voting tabulator validates the ballot 46 received from the voting entity. Once validated, the voting tabulator counts the votes and adds the vote to the total vote count 47.

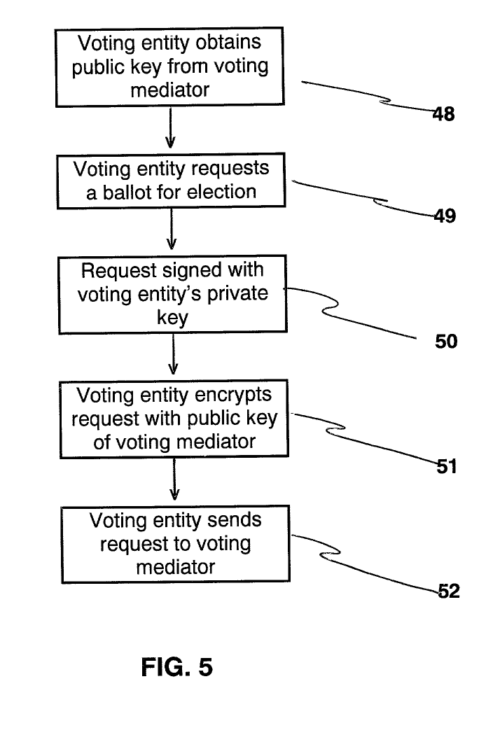

FIG. 5 shows the steps involved in requesting an anonymous electronic ballot from voting mediator 40. The first step 48 is for the voting entity to use its public key to obtain a certificate of the voting mediator. The voting entity can get to the voting mediator's certificate, such as through accessing an LDAP database. The voting entity then extracts the voting mediator's public key from the certificate. The voting entity requests an electronic ballot 49 by specifying unique election information, such as an identification number representing the state or local election. The request is signed 50 with the voting entity's private key. The signed request is then encrypted 51 with the voting mediator's public key. Only the corresponding private key can decrypt the encrypted information and only the voting mediator has the corresponding private key. The voting entity packages 52 the ballot request within a sealed object, consisting of a signature of the data and an encryption of the signed objects, and sends the sealed request to the voting mediator. Only the mediator has the corresponding private key that can decrypt the information and the mediator uses its private key to decrypt the ballot request.

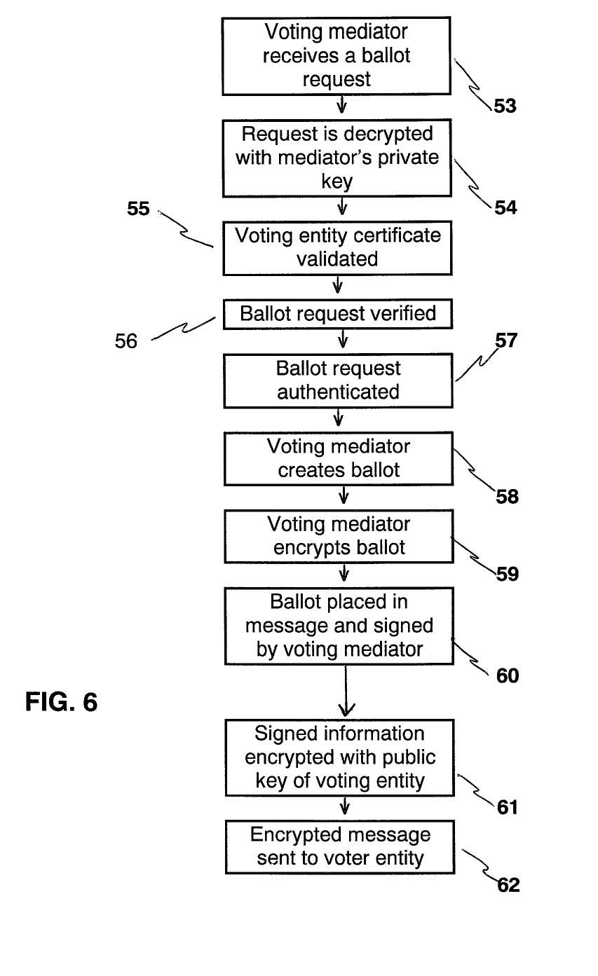

FIG. 6 shows the steps involved in validating the ballot request and generating an electronic ballot. The voting mediator receives the sealed (signed and encrypted) ballot request 53 and decrypts the encrypted ballot request with the mediator's private key to get the signed ballot request 54. The voting mediator validates the voting entity's certificate 55 and authenticates and verifies the integrity of the signed ballot request using the public key within the voting entity's certificate 56. The voting mediator validates the entity's certificate by ensuring that the certificate's validity period has not expired, that the certificate can be traced to a trusted root certificate, that the public key of the certificate issuer validates the signature of the certificate, and that the certificate does not exist on a Certificate Revocation List (CRL) issued by the certificate issuer. If the request is valid, the voting mediator authorizes the ballot request 57 by checking the signing certificate information against the appropriate election database, such as a registered voter roll for the state or municipality and whether or not the voting entity already voted in the target election. The voting entity's certificate information would include for example, the voter's address and precinct number. If the entity's certificate is valid, the mediator must ensure that the ballot request belongs to the entity requesting the ballot. The mediator extracts the public key from the entity's certificate and uses the entity's public key to validate the signature of the signed ballot request. The signature is an encrypted hash of the ballot request. The encryption of the hash was performed by the entity's private key. Once the mediator decrypts the encrypted hash with the public key of the entity, the mediator gets a decrypted hash. The mediator also computes the hash of the ballot request. If the decrypted has and the computed hashes are the same, the mediator has validated the ballot request came from the voting entity identified by the entity's certificate. If the request is authorized, the voting mediator creates an electronic ballot 58 consisting of the unique election identification and ballot serial number. The entire ballot is encrypted with the public key of the voting tabulator, which was obtained from the certificate of the voting tabulator 59. The voting mediator places the encrypted electronic ballot and voting tabulator's certificate in a message that is signed with the voting mediator's private key 60. The voting mediator also encrypts the signed information 61 with the public key of the voting entity before sending the signed and encrypted information, which includes the encrypted electronic ballot, to the voting entity 62.

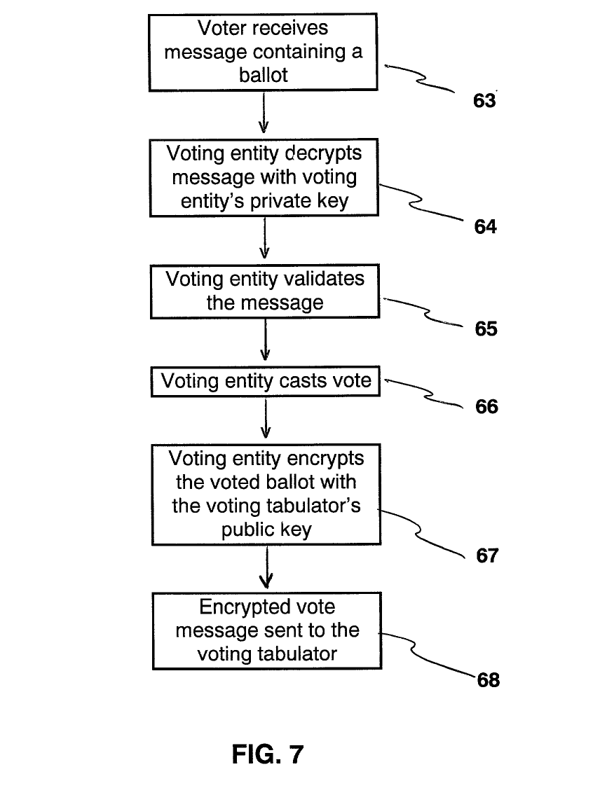

FIG. 7 illustrates the steps when the voting entity receives the electronic ballot and casts a vote in the election. The voting entity receives the signed and encrypted message, which includes the encrypted ballot from the voting mediator 63. Voting entity decrypts the encrypted message with the voting entity's private key 64 to get the signed message and validates 65 the signed message with the voting mediator's public key. Voting entity casts its votes 66 and encrypts the votes and the encrypted electronic ballot with the public key of the voting tabulator 67 before sending the encrypted voting information to the voting tabulator 68. The voting entity does not sign the request since the voting is anonymous.

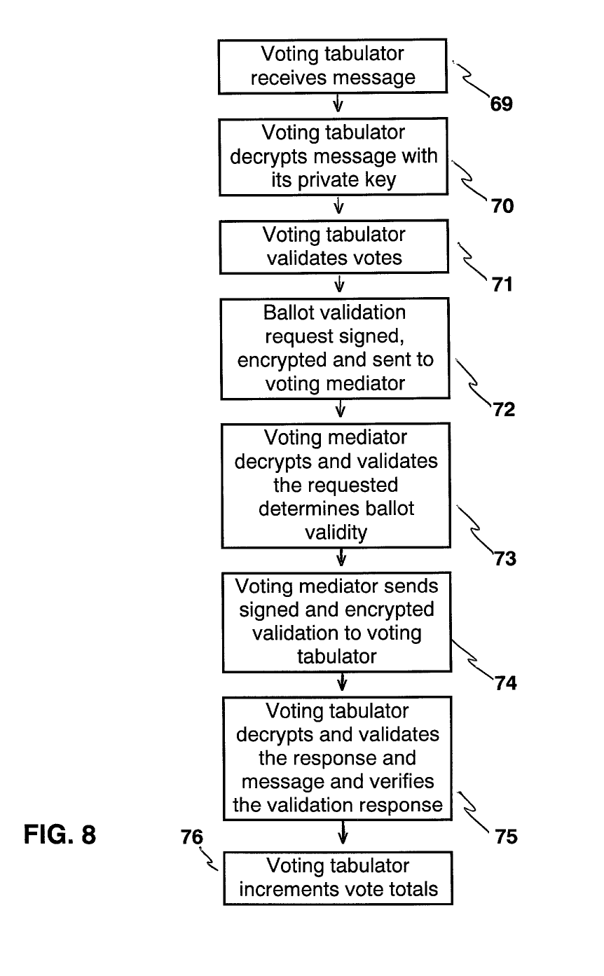

FIG. 8 shows the process of the voting tabulator receiving, validating and tabulating the electronic ballot. The voting tabulator receives the encrypted voting information from the voting entity 69 and decrypts the encrypted voting information with the tabulator's own private key 70, to get the votes and the encrypted electronic ballot. The voting tabulator ensures 71 that the votes are valid for the election it is tabulating. The voting tabulator signs, encrypts and sends the encrypted electronic ballot to the voting mediator 72 in a message that is encrypted with the voting mediator's public key and signed with the voting tabulator's private key. The voting mediator decrypts the encrypted ballot validation message with the voting mediator's private key and validates the validation request with the voting tabulator's public key. In this validation process, the votes come from the encrypted (but not signed) message that the tabulator received as part of an encrypted voting information message. The tabulator ensures that the votes are for the election it is tabulating by inspecting the data in the message. The tabulator must also ensure the ballot is valid. The message that the tabulator sends to the mediator is a verification message. The verification message does not contain the actual votes from the ballot, since the voting must be anonymous. Instead, the verification message contains identifying ballot information such as the ballot number, to ensure that it was issued by the mediator and has not been previously used. The mediator issues ballots only to registered voters. The tabulator signs the verification message with its privacy key. The signing process takes a hash of the message and uses the tabulator's private key to encrypt the hash. This process generates the message signature. The tabulator encrypts the signed message (the original message and its signature) with the public key of the mediator. The tabulator sends the encrypted and signed verification message to the mediator and the process continues. Next, the voting mediator decrypts the encrypted electronic ballot 73 with the voting mediator's private key and ensures that the decrypted ballot information is valid and has not been used before. The voting mediator sends back a signed and encrypted message to the voting tabulator 74 to indicate whether or not the electronic ballot is valid by signing the message with the voting mediator's private key and encrypting the signed message with the public key of the voting tabulator. The voting tabulator receives the signed and encrypted verification response message and decrypts the verification response with the voting tabulator's private key, as well validates the message signature 75 with the voting mediator's public key. If the electronic ballot is valid, the voting tabulator increments the vote totals 76 for the candidates and/or issues

The electronic voting architecture of the present invention has several advantages over the existing techniques, which are as follows:

The voting entity does not need a separate userid and password for each election. Voting entities can use the public and private key pair.

Voting is anonymous and confidential. The voting mediator does not know how the voting entity cast its ballots. The voting tabulator does not know where the ballot came from.

The architecture contains checks and balances to protect against fraud. The voting mediator can only read and verify the electronic ballot and the voting mediator ensures that the ballot cannot be used more than once and that multiple ballots cannot be issued to the same voting entity.

The architecture uses proven and vetted standards: public key technologies, Public Key Cryptography Standard (PKCS) #7 Signed Data and Encrypted Data objects, and Secure/Multipurpose Internet Mall Extension (S/MIME) messages to send secure transactions over the unsecured Internet.

While the invention has been particularly shown and described with reference to a preferred embodiment, it will be understood by those skilled in the art that various changes in form and detail may be made therein without departing from the spirit and scope of the invention.

We claim:

1. An improved method of electronic voting over a global computer network comprising the steps of:
requesting a voting ballot through a voting entity process using a public key and a private key of the voting entity;
validating said voting ballot request by a voting mediator, using a separate public key and private key of the voting mediator;
generating an electronic ballot by the voting mediator;
sending the generated ballot to said voting entity;
receiving a vote in said electronic ballot by said voting entity and sending said electronic ballot to a voting tabulator; and
counting the vote electronic ballot in the voting tabulator.

2. The method of claim 1 wherein said ballot requesting step further comprises:
obtaining a voting certificate from the voting mediator;
extracting the voting mediator's public key from the voting certificate;
encrypting the ballot request with the voting mediator's public key.

3. The method of claim 2 further comprising the step of packaging said ballot request within a sealed object, said sealed object comprising a signature of the data, voting certificate and an encryption of the sealed objects.

4. The method of claim 3 further comprising the step of signing said ballot request with voting entity's private key and sending said ballot request to the voting mediator.

5. The method of claim 4 further comprising the steps of:
receiving said ballot request by the voting mediator;
decrypting the encrypted ballot request with said voting mediator's private key;
validating said voting entity's certificate; and
authenticating and verifying the integrity of signed ballot request using the public key within said voting entity's certificate.

6. The method of claim 5 further comprising the step of authorizing a ballot request by checking the signing certificate information against the appropriate database; and determining whether said voting entity has previously voted in the identified election.

7. The method of claim 5 wherein the voting mediator validates said ballot request by ensuring that the validity period of the voting certificate has not expired, that the certificate can be traced to a root certificate and that the public key of the voting mediator validates the signature on the certificate

8. The method of claim 7 further comprising the step of ensuring that said ballot request comes from the voting entity requesting the ballot by extracting a public key from the voting entity's certificate and using the voting entity's public key to validate the signature of the signed ballot request.

9. The method of claim 1 wherein said ballot generating step further comprises the step of authorizing said ballot request by said voting mediator, said authorizing step comprising creating an electronic ballot having the unique election identification information and ballot number.

10. The method of claim 9 further comprising the steps of obtaining the public key of the voting tabulator and encrypting said generated ballot with said voting tabulator's public key before sending said signed and encrypted ballot to said voting entity.

11. The method of claim 1 further comprising before step (e) the step of receiving the signed and encrypted message containing the electronic ballot by said voting entity, decrypting the signed and encrypted message with the voting entity's private key to extract the information contained in the message and validating the signed message with said voting mediator's public key.

12. The method of claim 1 wherein the voting tabulator tabulates votes comprising the steps of:
receiving an encrypted voting information message;
inspecting the ballot contained in the message to ensure that votes are for the election the voting tabulator is tabulating;
requesting ballot validation from the voting mediator; and
tabulating votes from the received ballot.

13. The method of claim 12 wherein the voting mediator receives said validation request and decrypts and validates the ballot request to determine ballot validity.

14. The method of claim 13 further comprising the steps of:
sending signal and encrypted ballot validation to the voting tabulator by the voting mediator; and
receiving this response at the voting tabulator and validating and decrypting the response and verifying the validation response.

15. A system for implementing an electronic voting process over a global computer network comprising:
a voting entity said voting entity being a client process representing a person or group that will be voting in the election;
a voting mediator said voting mediator being a server process that authorizes and creates the anonymous electronic ballot for the voting entity; and
a voting tabulator said voting tabular being a server process that receives and validates the electronic ballot and tabulates the election results.

16. The architecture of claim 15 wherein each said voting entity, voting mediator and voting tabulator has a separate public key and private key.

17. A computer program product in a computer readable medium for electronic voting over a global computer network, the computer program product comprising:
instructions for requesting a voting ballot through a voting entity process using a public key and a private key of the voting entity;
instructions for validating said voting ballot request by a voting mediator, using a separate public key and private key of the voting mediator;
instructions for generating an electronic ballot by the voting mediator;
instructions for sending the generated ballot to said voting entity;
instructions for receiving a vote in said electronic ballot by said voting entity and sending said electronic ballot to a voting tabulator; and
instructions for counting the vote electronic ballot in the voting tabulator.

18. The computer program product as described in claim 17 wherein said ballot requesting instruction further comprises:
instructions for obtaining a voting certificate from the voting mediator;
instructions for extracting the voting mediator's public key from the voting certificate;
instructions for encrypting the ballot request with the voting mediator's public key.

19. The computer program product as described in claim 18 further comprising an instruction for packaging said ballot request within a sealed object, said sealed object comprising a signature of the data, voting certificate and an encryption of the sealed objects.

20. The computer program product as described in claim 19 further comprising an instruction for signing said ballot request with voting entity's private key and sending said ballot request to the voting mediator.

21. The computer program product as described in of claim 20 further comprising the steps of:
receiving said ballot request by the voting mediator;
decrypting the encrypted ballot request with said voting mediator's private key;
validating said voting entity's certificate; and
authenticating and verifying the integrity of signed ballot request using the public key within said voting entity's certificate.

22. A computer program product in a computer readable medium for representing a person or group that will be voting over a computer network, the computer program product comprising:
instructions for requesting an electronic voting ballot using a public key and a private key of said computer program product;
instructions for receiving the requested electronic voting ballot for the purpose of voting in an election voting the computer network;
instructions for receiving a vote on the electronic ballot, said voting being cast over a computer network; and
instructions for sending said electronic ballot to be tabulated.

23. A computer program product in a computer readable medium for authorizing and creating anonymous electronic ballots for use in voting over a computer network, the computer program product comprising:
instructions for receiving a ballot request;
instructions for decrypting the ballot request;
instructions for validating a voting certificate contained in the ballot request;
instructions for crating an electronic ballot based on information contained in the ballot request; and
instructions for sending a created electronic ballot to the source of the ballot request.

24. A computer program product in a computer readable medium for tabulating election results for an election in which electronic ballots, submitted over a computer network, are used, the computer program product comprising:
instructions for receiving encrypted voting information containing an electronic ballot;
instructions for decrypting the received encrypted voting information;
instructions for validating the electronic ballot contained in the voting information; and
instructions for incrementing vote totals to include votes of the electronic ballot contained in the received voting information.

25. A computer connectable to a distributed computing system including a process for voting electronically over said distributed system comprising:
a processor;
a native operating system to manage resources in the computing system;
a client program for representing a person or group that will be voting in an election;
a server program for authorizing and creating electronic voting ballots; and
a second server program for receiving, validating and tabulating electronic voting ballets.

26. The computer as described in claim 25 wherein each of said client program, server and second server has a separate public key and private key.
